(19) United States
(12) Patent Application Publication
(10) Pub. No.: US 2009/0002873 A1
(43) Pub. Date: Jan. 1, 2009

(54) Sensing Device for Sensing Installation Position of a Read Head

(76) Inventor: Chih-Mao SHIAO, Taichung (TW)

Correspondence Address: Dr. BANGER SHIA, 102 Lindencrest Ct., Sugar Land, TX, 77479-5201, US

(21) Appl. No.: 11/769,698

(22) Filed: Jun. 27, 2007

(51) Int. Cl. G11B 5/596

(52) U.S. Cl. 360/77.03

(57) ABSTRACT

A sensing device for sensing installation position of a read head is assembled on the read head correspondingly to a scale and comprises at least three sensing elements and three signal generators. The three sensing elements are located on one end surface of the read head facing the scale to sense the distance between the read head and the scale. According to the different distance, the respective signal generators will send out different signals to inform the user if the read head is correctly installed, thus ensuring the precision of the installation, the sensing operation and movement of the read head.

### BACKGROUND OF THE INVENTION

1. Field of the Invention

The present invention relates to a read head, and more particularly to a sensing device for sensing installation position of a read head.

2. Description of the Prior Art

Conventionally, in order to feed the movement distance of the mover back, a motor is usually provided with a read head assembled on the mover, and a scale assembled on the stator. The distance between mover and the stator can be known from the read head A and the scale B. Referring to FIG. 1, a conventional motor comprises a sensing element 10 and a light emitting element 20. The sensing element 10 is connected with the light emitting element 20. The sensing element 10 serves to sense the scale B, and when the sensing element 10 moves a certain distance away from the scale B, the light emitting element 20 will be turned on for informing the user that the read head A has been correctly installed at a proper position.

However, if this kind of read head A is installed in the manner as shown in FIG. 2 or 3, the distance between the sensing element 10 of the read head A and the scale B is within a proper sensing distance range, but the read head A is tilted in the left/right or front/back direction, the light emitting element 20 still will inform the user that the read head A has been correctly installed, thus causing the following two problems:

1. When the read head A and the scale B measure the moving distance of the mover, the inclination of the read head A will cause some errors in the measuring data. Under the current condition of high precision production, the tiny error can cause the finished product not to comply with the standard or the specification, or even not to reach the approving standard of the client.

2. Even though the light emitting element 20 doesn't emit light to indicate the read head A has not been correctly installed, the technician doesn't know which installation position or angle of the read head A has not been correctly installed, and has to check it out through repeated disassembly/assembly, thus causing time-wasting and low efficiency.

The root of the problem is that the sensing element 10 of the read head A cannot judge the inclination state of the read head A, so in order to solve the abovementioned problem, based on the research experience in the linear motor field, the applicant has developed a sensing device for sensing installation position of a read head, so as to sense the scale in all directions.

The present invention has arisen to mitigate and/or obviate the afore-described disadvantages.

### SUMMARY OF THE INVENTION

The primary objective of the present invention is to provide a sensing device for sensing installation position of a read head which utilizes at least three sensing elements disposed on the read head to correctly install the read head, so as to improve the precision of the read head sensing the scale.

In order to achieve the abovementioned objective, the read head is disposed with at least three sensing elements, and the three sensing elements are located on the end surface of the read head facing the scale. Additionally, the three sensing elements are not located at the same line.

Thereby, after the three sensing elements are located on the read head, as known form the principle that three points define a plane, the three sensing elements check the distance between the read head and the scale in a surface-to-surface manner but not in a conventional point-to-point manner, so the inclination of the read head can be known at the same time of checking if the read head is correctly installed. The sensing device for sensing installation position of a read head of the present invention has the following advantages:

1. Not only the distance of a single point of the read head to the scale but also the incline angle between the whole of the read head and the scale can be known, so as to improve the installation precision, and further improve the precision of the finished product, thus not only satisfying the client, but also reducing the defect rate and the material cost.

2. When the technician knows that the read head is not correctly installed, he only needs to check if the distance between respective sensing elements and the scale is within the proper distance range to know which installation position of the read head is tilted to cause the incorrect installation, thus saving the maintenance time and improving the work efficiency.

Furthermore, the read head is disposed with at least one signal generator connected with respective sensing elements to send out the signal to indicate if the distance between the respective sensing elements and the scale is within the proper distance range.

Moreover, based on the principle that three points define a plane, the quantity of the sensing elements is at least three. The quantity of the sensing elements can be increased according to requirement, but all the sensing elements are not located on the same line.

In addition, regarding the quantity of the signal generator, when only one signal generator is used, the signal generator can synchronously indicate the distance between the sensing elements and the scale. Also, one sensing element can be connected with one signal generator.

Additionally, the signal generator generates the signal by emitting light or sounding, and the signal generator can be disposed with a display screen to display the signal.

### BRIEF DESCRIPTION OF THE DRAWINGS

FIG. 1 is a perspective view of a conventional read head;

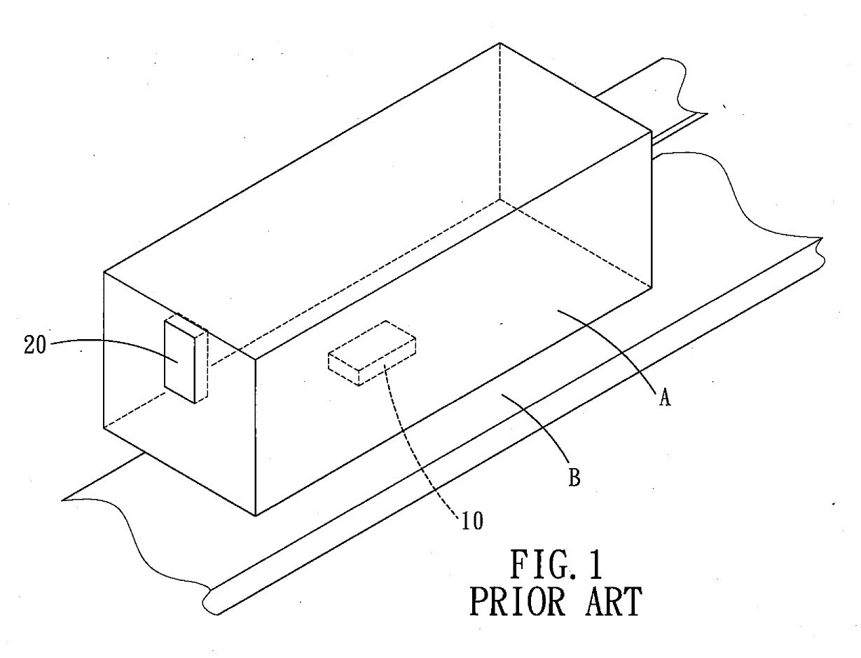

FIG. 2 is a cross sectional view of showing that the conventional read head is tilted;

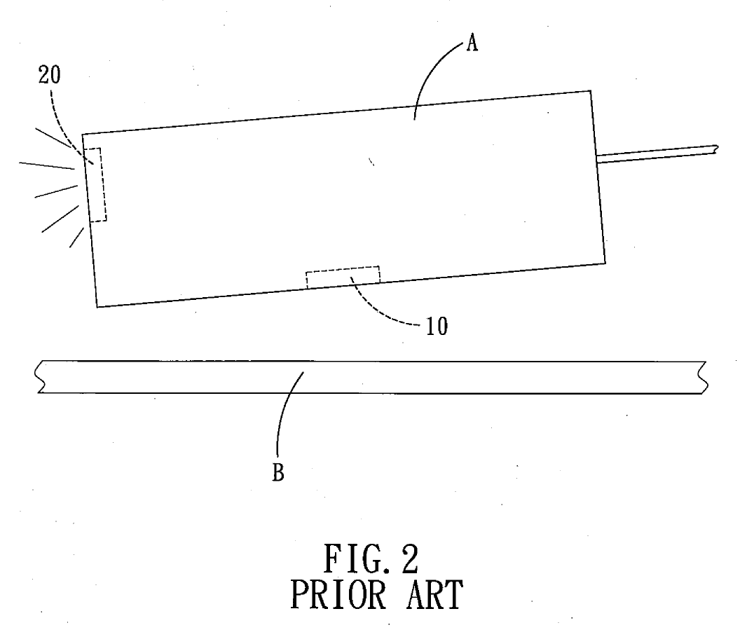

FIG. 3 is a front view of showing that the conventional read head is tilted;

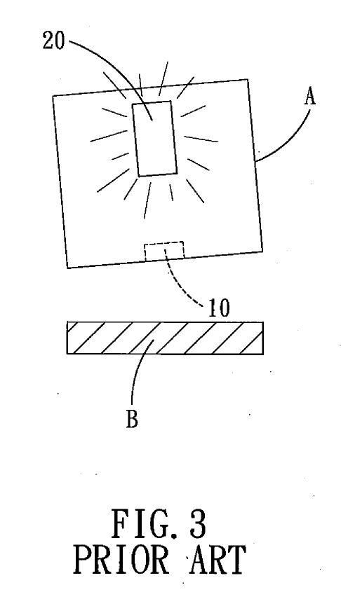

FIG. 4 is a perspective view of a sensing device for sensing installation position of a read head in accordance with the present invention;

FIG. 5 is a cross sectional view of showing the sensing device for sensing installation position of a read head is correctly installed in accordance with the present invention;

FIG. 6 is a front view of showing the sensing device for sensing installation position of a read head is correctly installed in accordance with the present invention;

FIG. 7 shows that the sensing device for sensing installation position of a read head is correctly installed and the signal generators are emitting light in accordance with the present invention;

FIG. 8 is a cross sectional view of showing the read head is tilted in accordance with the present invention;

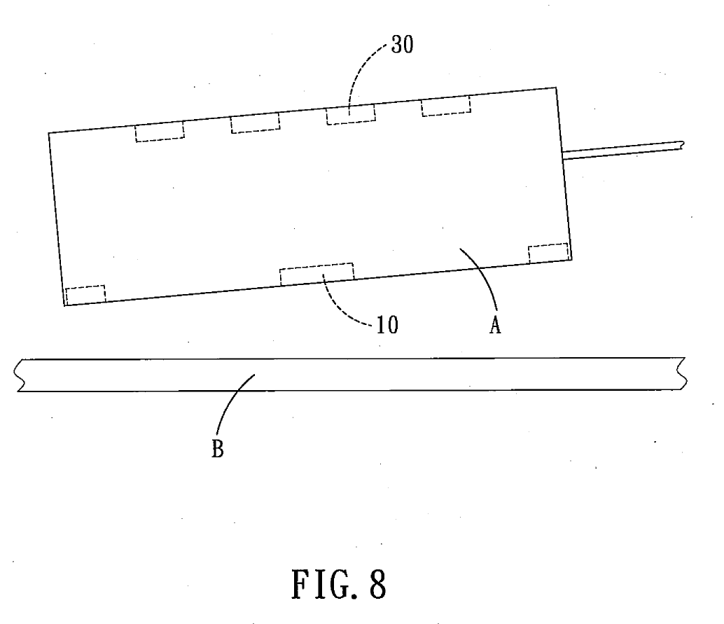

FIG. 9 is a front view of showing the read head is tilted in accordance with the present invention; and

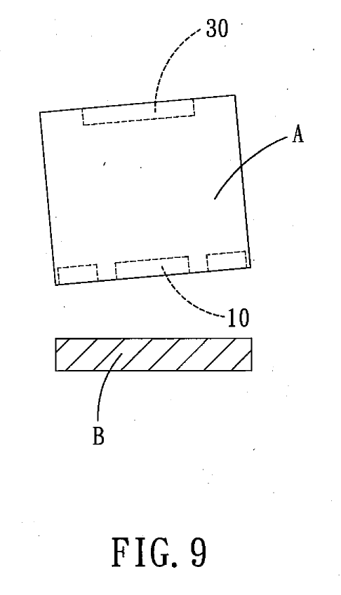

FIG. 10 shows that the read head is tilted and the signal generators are emitting light in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

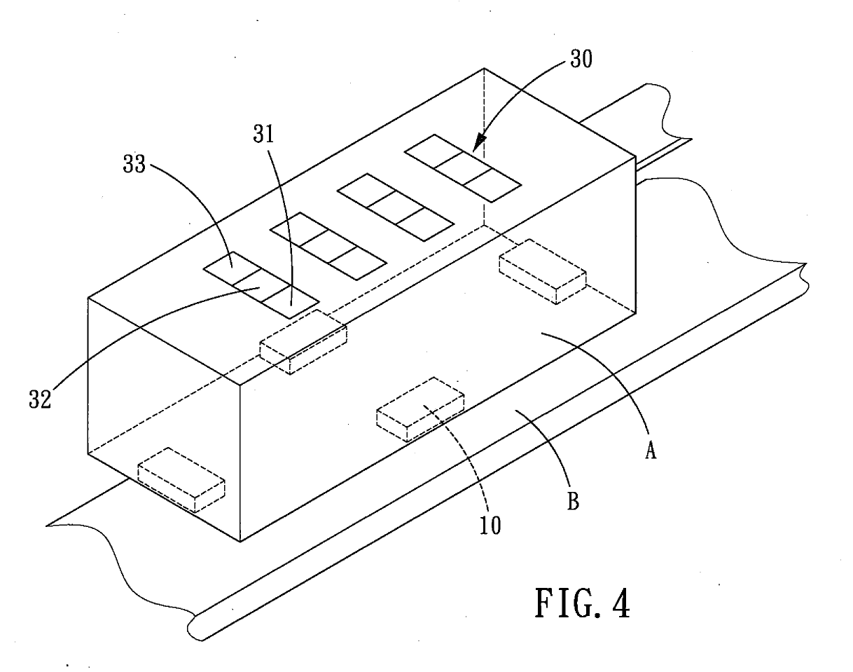

Referring to FIG. 4, a sensing device for sensing installation position of a read head in accordance with a preferred embodiment of the present invention is disposed on a read head A correspondingly to a scale B and comprises four sensing elements 10 and four signal generators 30. The read head A and the scale B can be disposed on a linear motor.

The four sensing elements 10 are disposed on the read head A and located on one surface of the read head A facing the scale B. The four sensing elements to are located at the front, back, left and right sides of the read head respectively. Furthermore, the sensing elements can be sensors and can synchronously sense and measure the scale B.

The four signal generators 30 are disposed on the read head A and located on a surface of the read head A opposite the surface where the four sensing elements 10 are located. The four signal generators 30 are connected with the four sensing elements 10 respectively. In this embodiment, the four signal generators 30 are successively connected to the front, left, right and the rear sensing elements 10 from front to back, respectively. These signal generators 30 indicate that respective sensing elements 10 are sensing the distance between itself and the scale B by emitting light. Moreover, each signal generator 30 includes a too-far indicating lamp 31, a correct indicating lamp 32 and a too-close indicating lamp 33 that are used to indicate that the installation position of the read head A is too far, correct and too close, respectively

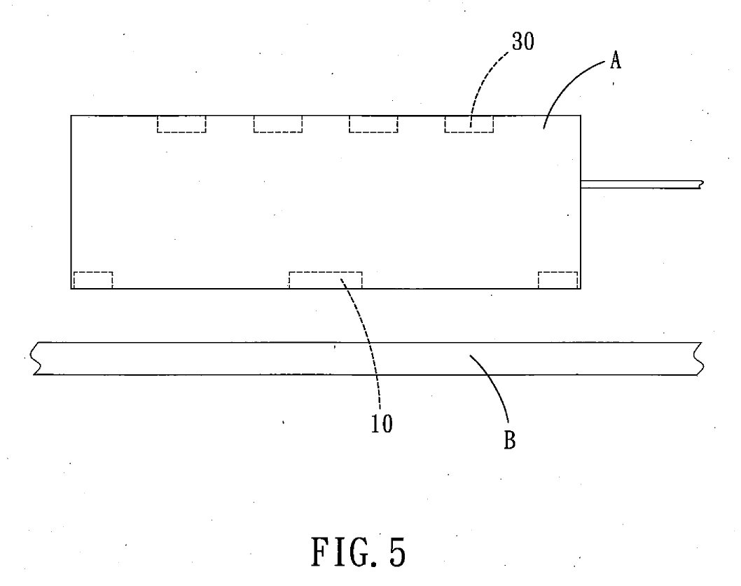

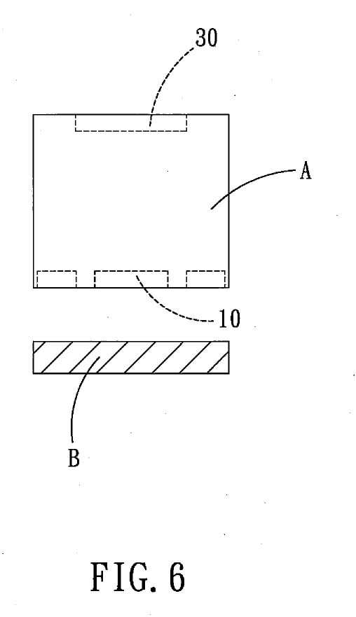

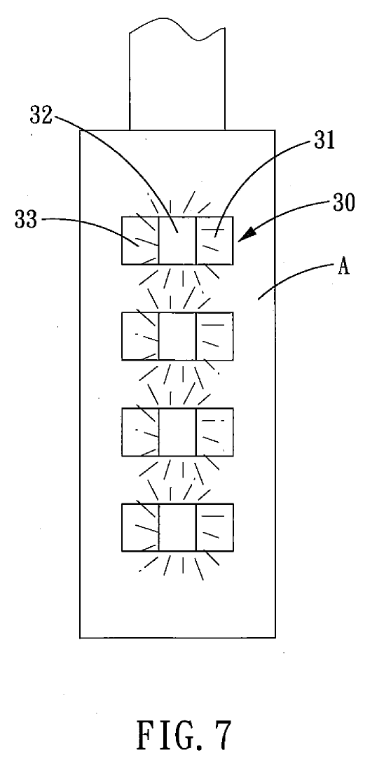

If the read head A is correctly installed, as shown in FIGS. 5-6, the respective sensing elements 10 senses that the distance to the scale B is proper, as shown in FIG. 7, all the correct indicating lamps 32 of the signal generators 30 will emit light, thereby indicating that both installation position and the installation angle of the read head A are correct.

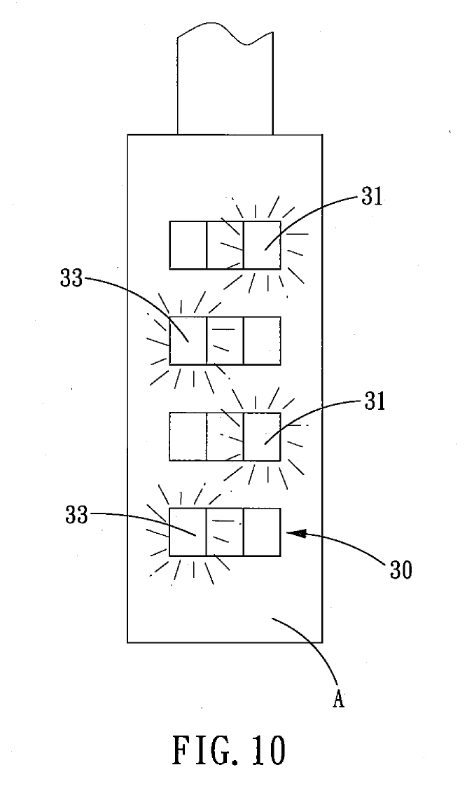

On the contrary, if the read head has not been correctly installed, the read head presented is tilted, the front and the right sensing elements 10 are located excessively close to the scale B, and the back and the left sensing elements 10 are excessively far away from the scale B, as shown in FIG. 10, the too-close indicating lamps 33 of the front and right signal generators 30 will emit light, and the too-far indicating lamps 33 of the back and the left signal generators 30 will emit light, thereby indicating that the read head A has not been correctly installed, the front and the right sides of the read head A is excessively close to the scale B and the back and the left side of the read head A are excessively far away from the scale B.

As known from the abovementioned description, the sensing device for sensing installation position of a read head of the present invention can explicitly indicate if the read head A is correctly installed, and which installation position of the read head A is tilted to cause the incorrect installation, thus achieving the following advantages: 1. improving the precision; 2. simplifying the maintenance or installation difficulty.

While we have shown and described various embodiments in accordance with the present invention, it is clear to those skilled in the art that further embodiments may be made without departing from the scope of the present invention.

What is claimed is:

1. A sensing device for sensing installation position of a read head being disposed on a read head correspondingly to a scale and comprising at least three sensing elements disposed on the read head and located on one end surface of the read head facing the scale, and all the sensing elements are not located at the same line.

2. The sensing device for sensing installation position of a read head as claimed in claim 1 further comprising at least one signal generator disposed on the read head and connected with the sensing elements.

3. The sensing device for sensing installation position of a read head as claimed in claim 2, wherein a quantity of the signal generators is the same as a quantity of the sensing elements, and each signal generator is connected with each sensing element.

4. The sensing device for sensing installation position of a read head as claimed in claim 2, wherein each signal generator generates a signal by emitting light.

5. The sensing device for sensing installation position of a read head as claimed in claim 2, wherein each signal generator includes a too-far indicating lamp, a correct indicating lamp and a too close indicating lamp.

6. The sensing device for sensing installation position of a read head as claimed in claim 2, wherein each signal generator generates a signal by sounding.

7. The sensing device for sensing installation position of a read head as claimed in claim 2, wherein each signal generator is disposed with a display screen to display the signal.

8. The sensing device for sensing installation position of a read head as claimed in claim 1, wherein the sensing elements are sensors.

9. The sensing device for sensing installation position of a read head as claimed in claim 1, wherein the quantity of the sensing elements is four, and the four sensing elements are located at the front, back, left and right sides of the read head respectively.

10. The sensing device for sensing installation position of a read head as claimed in claim 9, wherein the read head is disposed with at least one signal generator, and the signal generators are connected with the four sensing elements.

11. The sensing device for sensing installation position of a read head as claimed in claim 10, wherein the quantity of the signal generators is four, and each sensing element is connected with each signal generator.

12. The sensing device for sensing installation position of a read head as claimed in claim 10, wherein each signal generator generates the signal by emitting light.

13. The sensing device for sensing installation position of a read head as claimed in claim 12, wherein each signal generator includes a too-far indicating lamp, a correct indicating lamp and a too-close indicating lamp.

14. The sensing device for sensing installation position of a read head as claimed in claim 10, wherein each signal generator generates the signal by sounding.

15. The sensing device for sensing installation position of a read head as claimed in claim 10, each signal generator is disposed with a display screen to display the signal.

16. The sensing device for sensing installation position of a read head as claimed in claim 9, wherein the sensing elements are sensors.
